(19) United States
(12) Patent Application Publication
(10) Pub. No.: US 2015/0149205 A1
(43) Pub. Date: May 28, 2015

(54) INTEGRATED CLINICAL DECISION SUPPORTING SYSTEM AND METHOD

(71) Applicants: Sung-Young Lee, Seongnam-si (KR); Hussain Maqbool, Yongin-si (KR)

(72) Inventors: Sung-Young Lee, Seongnam-si (KR); Hussain Maqbool, Yongin-si (KR)

(73) Assignee: University-Industry Cooperation Group of Kyung Hee University, Yongin-si (KR)

(21) Appl. No.: 14/091,631

(22) Filed: Nov. 27, 2013

(51) Int. Cl. G06F 19/00

(52) U.S. Cl. CPC G06F 19/345
USPC 705/3

(57) ABSTRACT

Integrated clinical decision supporting system and method are provided. The system includes a CDSS application terminal configured to consume a user's clinical information including medical data, social media data, and sensor measuring data, and transmit the collected user's clinical information, and an integrated clinical decision supporting apparatus configured to convert the user's clinical information received from the CDSS application terminal into a predetermined standard format, and generate a medical recommendation based on the converted user's clinical information and a previously stored clinical rule.

### BACKGROUND

1. Field

The following description relates to a clinical decision supporting system, and more particularly, to integrated clinical decision supporting system and method which provides interoperability between clinical decision supporting systems with heterogeneous characteristics.

2. Description of the Related Art

A medical institution in the past used a method of recording patient-related information into a paper or film, etc., but a record system for storing a patient's medical record using an electronic health record (EHR) is currently developed and used. Medical institutions can offer a much better service by sharing and exchanging clinical information with various fields requiring corresponding information through the EHR. Further, according to a combination between supplies of equipment for measuring a patient's health condition and developments of technology including information technology (IT), nanotechnology (NT), and biotechnology (BT), much more various medical services can be offered.

The rise in living standards generated by developments of new technology increases a request for a high-quality health care service. The increase of the request for the high-quality health care service has brought the appearance of information and communication technology based on a clinical decision supporting system (CDSS) and an online health care system/application program.

Various study results included in a paper titled “Clinical decision support capabilities of commercially-available clinical information systems” in Journal of the American Medical Informatics Association published in 2009 show that the EHR may improve a patient's treatment, reduce mistakes, and reduce a time, if a proper CDSS is provided. However, although the CDSS improves the patent's treatment and reduces costs for health management, the CDSS is not widely used. There are major barrier factors that workflows of health management systems provided in various institutions or companies are not integrated and medical knowledge is not shared. Moreover, a conventional CDSS offers only a limited support for adaptation and maintenance for future emerging medical knowledge. Moreover, data exchange is difficult due to the lack of standardization for each of the health management systems or the CDSSs and the use of different data formats according to the use of a proprietary data format. That is, since each institution providing each medical field or a medical service equips and uses a different CDSS, sharing of information or knowledge between one another is not properly achieved and workflows are not integrated, either. For this reason, interoperability between the CDSSs with heterogeneous characteristics cannot be achieved, and accumulation of standardized knowledge is difficult.

### SUMMARY

The following description relates to integrated clinical decision supporting system and method for providing integration and interoperability between clinical decision supporting systems different from one another with heterogeneous characteristics.

In one general aspect, an integrated clinical decision supporting system includes a CDSS application terminal configured to collect a user's clinical information including medical data, social media data, and sensor measuring data, and transmit the collected user's clinical information, and an integrated clinical decision supporting apparatus configured to convert the user's clinical information received from the CDSS application terminal into a predetermined standard format, and generate a medical recommendation based on the converted user's clinical information and a previously stored clinical rule. The CDSS application terminal may include a health management information managing unit configured to collect the medical data for a user in an health management information system, a social media data managing unit configured to collect the social media data including social network information, trajectory information, and e-mail information for the user, and an activity/sentiment recognizing unit configured to collect the sensor measuring data for recognizing activity and sentiment from the user. The predetermined standard format may be HL7 vMR (Health Level 7 Virtual Medical Record).

In another general aspect, an integrated clinical decision supporting method includes receiving a user's clinical information including medical data, social media data, and sensor measuring data, and converting the received user's clinical information into a predetermined standard format. When the user's clinical information is converted into the predetermined standard format, the method also includes generating a medical recommendation based on the converted user's clinical information and a previously stored clinical rule. The method further includes converting the generated medical recommendation into a data format corresponding to a terminal of the user, and transmitting the converted medical recommendation to the CDSS application terminal.

Other features and aspects will be apparent from the following detailed description, the drawings, and the claims.

### BRIEF DESCRIPTION OF THE DRAWINGS

FIG. 1 is a diagram illustrating an integrated clinical decision supporting system according to an exemplary embodiment of the present invention;

FIG. 2 is a detailed diagram illustrating an adaptation engine unit of an integrated clinical decision supporting system according to an exemplary embodiment of the present invention;

FIG. 3 is a detailed diagram illustrating a CDSS application terminal of an integrated clinical decision supporting system according to an exemplary embodiment of the present invention; and

FIG. 4 is a flowchart for describing an integrated clinical decision supporting method according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

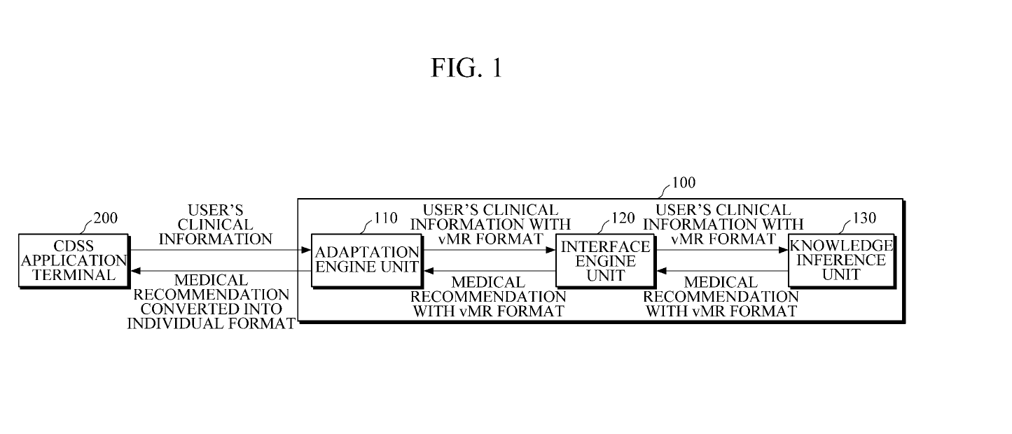

FIG. 1 is a diagram illustrating an integrated clinical decision supporting system according to an exemplary embodiment of the present invention.

Referring to FIG. 1, an integrated clinical decision supporting system according to an exemplary embodiment of the present invention includes an integrated clinical decision supporting apparatus 100, and at least one clinical decision supporting system (CDSS) application terminal 200.

The CDSS application terminal 200 provides a user's clinical information through an interaction with the integrated clinical decision supporting apparatus 100, and receives a medical recommendation from the integrated clinical decision supporting apparatus 100. The CDSS application terminal 200 may include a general health management information system (HMIS) including an electronic medical record (EMR) and an electronic health record (EHR), and may also include a smart device for installing and executing a health management-related application program, a terminal for collecting the user's health information, and a basic measuring apparatus for measuring the user's weight/body mass index (BMI). Further, the CDSS application terminal 200 may include a terminal for collecting information from social media such as the user's Twitter or Facebook. The CDSS application terminal 200 may include not only a specific apparatus made for a medical purpose, but also every terminal for providing a related function or being capable of installing a related application program and an apparatus being capable of measuring the user's body activity or biosignal.

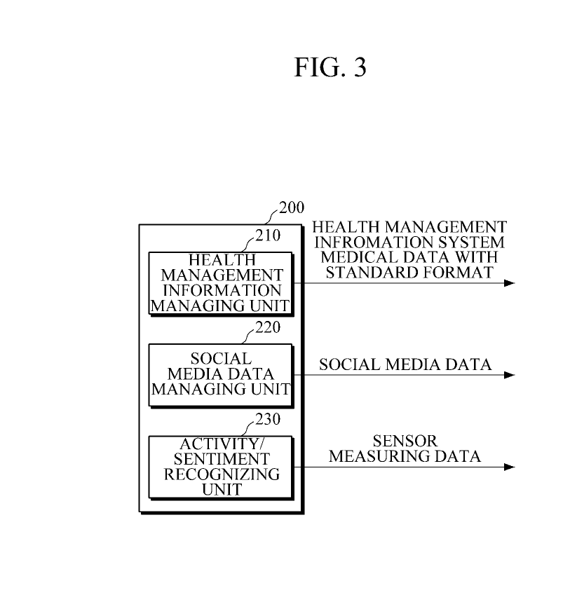

The CDSS application terminal 200 collects the user's clinical information including the user's medical data, social media data, and sensor measuring data of its proprietary format, and transmits the collected user's clinical information to the integrated clinical decision supporting apparatus 100. The user's clinical information further includes EMR data, EHR data, health management-related application program data, health information measured from the user, and social media-related information. The user's clinical information that the at least one CDSS application terminal 200 transmits to the integrated clinical decision supporting apparatus 100 can be transmitted regardless of a data format or pattern. The CDSS application terminal 200 will be further explained hereinafter with reference to FIG. 3.

The integrated clinical decision supporting apparatus 100 includes an adaptation engine unit 110, an interface engine unit 120, and a knowledge inference unit 130.

The adaptation engine unit 110 converts the user's clinical information received from the CDSS application terminal 200 into one standard data format regardless of a data format. Each medical institution can use a different data format (an individual format) when recording the EMR and/or the EHR. The different data format used when recording the EMR and the EHR may be a data format regulated by one of a generally known or standard format such as a health level 7 clinical document architecture (HL7 CDA), or be an individual format independently used in the each medical institution. The HL7 CDA is a clinical document architecture (CDA) offering a data structure model of an extensible mark-up language (XML) type being capable of exchanging clinical information online, and is an integrated information model for supporting many kinds of medical document types such as a radiation recording paper, a process recording paper, a clinical summary paper, a hospitalization/discharge summary paper, etc. based on a health level 7 reference information model (HL7 RIM). If the received user's clinical information is one regulated data format such as the HL7 CDA, the adaptation engine unit 110 converts the received user's clinical information into a health level 7 virtual medical record (HL7 vMR) format using an adaptive interoperability engine. The HL7 is ANSI (American National Standard Institute) accredited standard body providing set of standards in various domains which can allow health medical field software applications different from each other to be compatible, and is one of standards for an electronic exchange of clinical information. The HL7 vMR format is an interface format supported by the HL7 which is common data model allowing the health medical field software applications different from each other to be compatible, and is a simplified and standardized EHR data model supporting an interface for the CDSS connection.

The adaptation engine unit 110 converts the social media data collected from the user's social media in the user's clinical information received from the CDSS application terminal 200 into the HL7 vMR format. The present invention uses a vMR format for monitoring a patient's motion from the social media data and analyzing a patient's trajectory. Further, the adaptation engine unit 110 converts the sensor measuring data included in the user's clinical information into the vMR format.

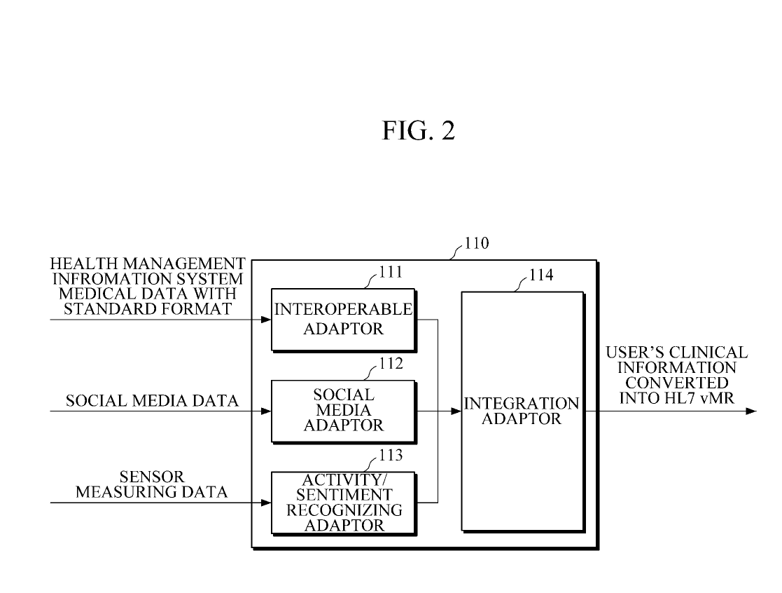

The EMR and/or EHR of the individual medical institution may be formed as a data format included in the above-described HL7 standard, but a specific medical institution may use a completely independent data format and pattern which are not general or not widely known. In this case, since it is difficult to find the completely independent data format exactly, it is difficult for the adaptation engine unit 110 to convert the completely independent data format into the vMR format. Therefore, the adaptation engine unit 110 finds contents of the user's clinical information with the completely independent data format using ontology technology, and corresponds the found contents to the vMR format. Since the adaptation engine unit 110 converts a medical recommendation, a clinical rule, and clinical knowledge information into a data format corresponding to a counterpart medical institution or terminal and transmits them to the counterpart medical institution or terminal, the integrated clinical decision supporting apparatus 100 according to the present invention can share knowledge and information more effectively. The adaptation engine unit 110 will be further explained hereinafter with reference to FIG. 2.

The interface engine unit 120 is an input and output interface operating based on the HL7 vMR, and is provided together with a standard vMR scheme. The interface engine unit 120 performs an input and output operation between the adaptation engine unit 110 and the knowledge inference unit 130 based on the vMR scheme. The interface engine unit 120 transmits the user's clinical information and/or medical knowledge information converted into the HL7 vMR format in the adaptation engine unit 110 to the knowledge inference unit 130. Further, the interface engine unit 120 transmits the medical recommendation information generated in the knowledge inference unit 130 to the adaptation engine unit 110.

The knowledge inference unit 130 receives the user's clinical information converted into the HL7 vMR in the adaptation engine unit 110 through the interface engine unit 120. The knowledge inference unit 130 generates the medical recommendation proper to the user by applying the user's clinical information converted into the HL7 vMR to the clinical rule stored in a knowledge base.

The knowledge inference unit 130 operates based on an HL7 Arden Syntax representing medical knowledge. The Arden Syntax is made for promoting knowledge sharing between knowledge-based systems as a standard of American National Standards Institute (ANSI), HL7, and represents a logic as a procedural representation which is easily written. The knowledge inference unit 130 includes a knowledge base configured of a clinical rule with a consistent unit type through a medical logic module (MLM). The MLM is a logic module for decision and knowledge support, and is an independent unit in a health management knowledge base representing knowledge shown upon a request for treating the patient according to a single clinical decision. The MLM can be used in a situation monitoring program in an intensive care unit or a hospital information system.

The MLM of the knowledge inference unit 130 acquires a decision based on clinical knowledge or an evidence from an online resource. At the same time, the MLM is converted into an executable file format. The knowledge inference unit 130 can secure interoperability of a workflow by sharing the workflow with an external institution or CDSS through the MLM converted into the executable file format. The MLM operates on data shared by a user application in the vMR format. That is, the knowledge inference unit 130 stores the clinical rule and user's clinical information using the MLM, and shares the workflow with the external institution by sharing the MLM converted into the executable file format with the external institution. Further, the knowledge inference unit 130 finds a user's application context from the user's clinical information received from the CDSS application terminal 200. The knowledge inference unit 130 sets the workflow to allow the MLM to be executed properly.

Since the knowledge inference unit 130 according to the present invention can convert various health-related information including the user's clinical information and clinical knowledge information received from the adaptation engine unit 110 into the HL7 vMR standard and store the clinical rule through the MLM based on the HL7 vMR standard, the knowledge inference unit 130 can share the workflow with other institutions or CDSSs, and share various health-related information such as clinical knowledge information that the other clinical institutions or CDSSs have. Further, since the clinical rule and generated medical recommendation stored in the knowledge inference unit 130 are transmitted by being converted into various data formats through the adaptation engine unit 110, the knowledge inference unit 130 can secure interoperability by sharing information and workflow with the other institutions or CDSSs regardless of a data format and rule.

The knowledge inference unit 130 receives the user's clinical information including the user's medical data, social media data, and sensor measuring data converted into the vMR format through the adaptation engine unit 110 from the CDSS application terminal 200. The knowledge inference unit 130 monitors a patient's health condition, emotion, and interest by analyzing a social network such as the patient's Twitter, and the patient's trajectory and e-mail.

The knowledge inference unit 130 extracts a keyword, a concept, and a sentiment from social network information (a writing that a user inputs or receives through the social network) included in the social media data. Further, the knowledge inference unit 130 analyzes the user's trajectory included in the social media data, and extracts the user's focused activities considering an imperative location and a semantic tag corresponding to the predetermined user. Further, the knowledge inference unit 130 extracts an interesting pattern in the user's routine by analyzing e-mail information included in the social media data. The knowledge inference unit 130 generates the medical recommendation more effectively by additionally considering the extracted keyword, concept, sentiment, focused activities, and interesting pattern.

The knowledge inference unit 130 provides capability of verifying and validating the newly published rules by clinicians. It supports mechanism of case based reasoning (CBR) which associates cases with each MLM. During creation of new MLM, the inference engine load all related cases. The new MLM is considered new one if no case is exactly matched and case base is revised with addition of new cases for this MLM.

FIG. 2 is a detailed diagram illustrating an adaptation engine unit of an integrated clinical decision supporting system according to an exemplary embodiment of the present invention.

Referring to FIG. 2, an adaptation engine unit 110 includes an interoperable adaptor 111, a social media adaptor 112, an activity/sentiment recognizing adaptor 113, and an integration adaptor 114.

The adaptation engine unit 110 converts a user's clinical information with a complicate heterogeneous characteristics into an input of the integrated clinical decision supporting apparatus 100 based on the HL7 vMR standard. Further, the adaptation engine unit 110 converts data including a clinical rule, a medical recommendation, clinical knowledge information, etc. into a data format proper to a target and outputs the converted data. The adaptation engine unit 110 may provide a plug-in interface for each of individual user application terminals or external institutions. When an information or data process is performed as a format that each of the CDSS application terminal or HMISs can interpret, the integrated clinical decision supporting apparatus (system) may have interoperability with the CDSS application terminal or the HMIS.

The interoperable adaptor 111 solves heterogeneous characteristics between formats of the HMISs, and enables interactions with the HMIS or CDSS application terminal of the external institution. The interoperable adaptor 111 is a subcomponent configuring the adaptation engine unit 110, and performs a mediator role between the integrated clinical decision supporting apparatus and the external HMIS. Generally, since the HMIS follows a health care standard, the HMIS can use only a standardized format. For example, the HMIS uses a standardized format generally used in a corresponding field such as HL7 CDA, openEHR, and CEN13606. On the other hand, the integrated clinical decision supporting apparatus according to the present invention processes data as the HL7 vMR format.

The interoperable adaptor 111 enables interoperable communication with the HMIS. In order to enable the interoperable communication with the HMIS, the interoperable adaptor 111 provides a bridge service using ontology matching technology of generating a mapping between health care standards.

When the user's clinical information including the user's medical data, clinical rule, medical recommendation, and/or clinical knowledge information is input from an external institution including the HMIS or a terminal including the HMIS as a standard data format (for example, a format such as HL7 CDA) of the HMIS, the interoperable adaptor 111 converts the user's clinical information into a vMR format using a previously stored ontology mapping. Further, the user's clinical information converted into the vMR format by the interoperable adaptor 111 is transmitted to the knowledge inference unit 130 through the interface engine unit 120. The knowledge inference unit 130 generates the medical recommendation as the vMR format based on the user's clinical information with the vMR format transmitted from the interoperable adaptor 111 and the stored clinical rule/clinical knowledge information, and transmits the generated medical recommendation to the interoperable adaptor 111. The interoperable adaptor 111 converts the received medical recommendation with the vMR format into a standard data format of the HMIS, and transmits the converted medical recommendation to a target including a corresponding HMIS. The standard data format of the HMIS converted by the interoperable adaptor 111 corresponds to a standard data format of the HMIS receiving a corresponding medical recommendation.

The social media adaptor 112 converts a data format of the received social media data into the vMR format, and transmits the converted social media data to the knowledge inference unit 130 through the interface engine unit 120. The social media data includes a user's (patient's) social network, trajectory, and e-mail information. The social media adaptor 112 converts an individual format of the social media data including the social network, trajectory, and e-mail information into the vMR format. Accordingly, the integrated clinical decision supporting apparatus can access and use the social media data regardless of a kind of social media data and a data format.

The activity/sentiment recognizing adaptor 113 converts sensor measuring data received from the CDSS application terminal 200 into the vMR format regardless of a format. The received sensor measuring data is sensor data measured from the user (patient). The integrated clinical decision supporting apparatus according to the present invention recognizes the patient's activity and sentiment conditions from the measured sensor data, and considers the recognized patient's activity and sentiment conditions for generating the medical recommendation.

TABLE 1
vMR conversion sample of the activity/sentiment
recognizing adaptor 113

<?xml version=“1.0” encoding=“UTF-8”?>
<activities>
<activity type=“Motion”>
<detectedBy>Motion Sensor</detectedBy>
<hasName>Mr J</hasName>
<activityName>Leaving Bedroom</activityName>
<id>1</id>
<time>2011:05:16:01:00:00</time>
</activity>
.........................
<activity type=“Medicine”>
<detectedBy>Wearable Sensor</detectedBy>
<hasName>Mr J</hasName>
<activityName>Taking Medication</activityName>
<id>5</id>
<time>2011:05:16:01:10:40</time>
</activity>
.........................
</activities>
Corresponding vMR can be seen as follows;
<vmrInput>
<templateId root=“2.16.840.1.113883.3.795.11.1.1”/>
<patient>
...........
<clinicalStatements>
<!-- current problems -->
<problems>
<problem>
<id root=“d7ebd80c-a28f-438f-9457-d3f92ea124ad”/>
<!-- Diabetes -->
<problemCode codeSystem=“2.16.840.1.113883.6.96”
codeSystemName=“SNOMED CT” code=“73211009”/>
</problem>
</problems>
<!-- current medications -->
<substanceAdministrationEvents>
<substanceAdministrationEvent>
<id root=“54277620-9128-4c13-8fc8-623a38532627”/>
<substance>
<id root=“2c803900-c8d1-457d-9567-4c92d75a0e23”/>
<!-- Morning after diabetic pill -->
<substanceCode codeSystem=“2.16.840.1.113883.6.96”
codeSystemName=“SNOMED CT” code=“102954005” />
</substance>
<documentationTime low=“20110516” high=“20110516”/>
</substanceAdministrationEvent>
</substanceAdministrationEvents>
</clinicalStatements>
</patient>
</vmrInput>

Table 1 illustrates an embodiment of the vMR conversion sample of the activity/sentiment recognizing adaptor 113. The activity/sentiment recognizing adaptor 113 converts the received sensor measuring data into the vMR format, and transmits the converted sensor measuring data to the knowledge inference unit 130. The received sensor measuring data may include various data such as motion sensor data for recognizing the patient's activity or sentiment condition, heart rate measuring data, temperature data, respiration state data, muscle activity data, blood amount pulse data, etc.

The integration adaptor 114 performs an integration of context information with the same context among the vMR format data converted in the interoperable adaptor 111, the social media adaptor 112, and the activity/sentiment recognizing adaptor 113. The integration adaptor 114 transmits the integrated context information to the knowledge inference unit 130. Further, the integration adaptor 114 transmits data received from the interoperable adaptor 111, the social media adaptor 112, and the activity/sentiment recognizing adaptor 113 to the knowledge inference unit 130.

When the medical recommendation, clinical rule, or clinical knowledge information with the vMR format are received, the adaptation engine unit 110 again converts the medical recommendation, clinical rule, or clinical knowledge information with the vMR format into a data format required by the CDSS application terminal or medical institution. The integrated clinical decision supporting apparatus can have interoperability with various CDSS application terminals or medical institutions using an independent data format.

FIG. 3 is a detailed diagram illustrating a CDSS application terminal of an integrated clinical decision supporting system according to an exemplary embodiment of the present invention.

Referring to FIG. 3, a CDSS application terminal 200 of an integrated clinical decision supporting system according to an exemplary embodiment of the present invention provides a user's clinical information through an interoperation with an integrated clinical decision supporting apparatus 100, and receives a medical recommendation from the integrated clinical decision supporting apparatus 100.

The CDSS application terminal 200 includes a health management information managing unit 210, a social media data managing unit 220, and an activity/sentiment recognizing unit 230.

The health management information managing unit 210 transmits clinical information included in the HMIS such as EMR or EHR to the integrated clinical decision supporting apparatus 100. Generally, since the HMIS follows a health care standard, the HMIS can only use a standard format. For example, the HMIS uses a standard format used in a corresponding field such as HL7 CDA, openEHR, and CEN13606. The health management information managing unit 210 may be the HMIS itself used in various medical institutions, and be a terminal being capable of accessing the HMIS and collecting the clinical information. Further, the health management information managing unit 210 may be implemented as a type of an application program in a smart device or a mobile terminal such as a smartphone, and can collect information from a specific HMIS.

The social media data managing unit 220 collects social media data including a user's social network, trajectory, and e-mail, and transmits the collected social media data to the integrated clinical decision supporting apparatus 100. The social media data includes the user's (patient's) social network information, trajectory information, and e-mail information. The social network information includes a writing that a user wrote on a social network such as Twitter or Facebook and a writing transferred to the user. The social media data managing unit 220 monitors the social network that the user uses, collects the writing related to the user, and transmits the collected writing to the integrated clinical decision supporting apparatus 100. The trajectory information is information for the user's real trajectory, and can be collected through a position tracking system such as a global positioning system (GPS).

The activity/sentiment recognizing unit 230 transmits sensor measuring data collected from the user to the integrated clinical decision supporting apparatus 100. The collected sensor measuring data is measuring data for recognizing the user's activity and sentiment measured from a user, and may include clinical measuring data such as electrocardiogram, temperature, pulse, weight, BMI, and muscular condition, and the user's motion measuring data. The activity/sentiment recognizing unit 230 may include a measuring apparatus for measuring various data from a user, and may be implemented as an apparatus for collecting the sensor measuring data from a measuring apparatus, or a type of application program for collecting the sensor measuring data from the measuring apparatus.

The CDSS application terminal 200 including the health management information managing unit 210, the social media data managing unit 220, and the activity/sentiment recognizing unit 230 collects the user's clinical information regardless of a format of the collected user's clinical information, and transmits the collected user's clinical information to the integrated clinical decision supporting apparatus 100.

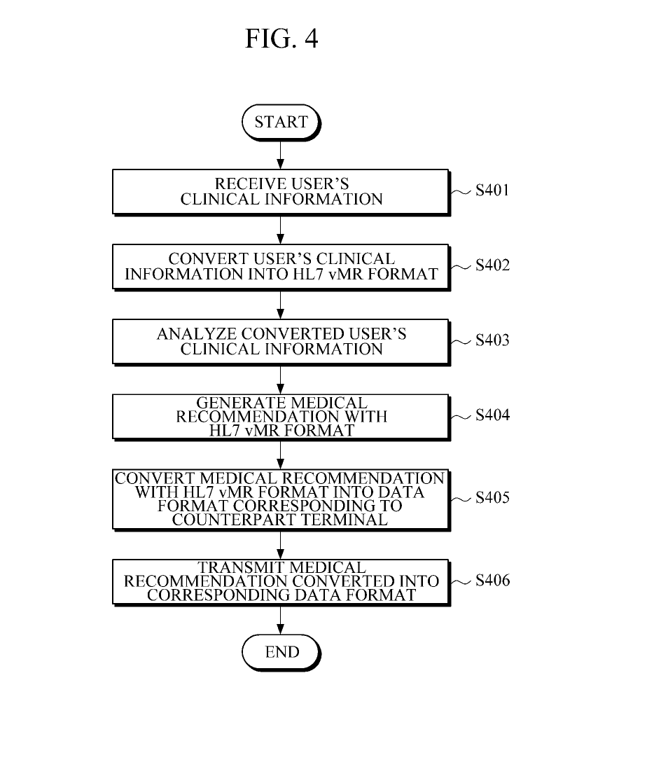

FIG. 4 is a flowchart for describing an integrated clinical decision supporting method according to an exemplary embodiment of the present invention.

Referring to FIG. 4, an integrated clinical decision supporting method according to an exemplary embodiment of the present invention includes receiving a user's clinical information (401). The user's clinical information includes user's medical data, social media data, and sensor measuring data with a standard format of a general HMIS including EMR and EHR. The received user's clinical information may have different data formats according to application terminal, medical institution, or a kind of sensor. The HMIS such as the EMR or EHR can generally use only a standard format. For example, the HMIS uses a standard format generally used in a corresponding field such as HL7 CDA, openEHR, and CEN13606.

The social media data included in the received user's clinical information includes user's social network information, user's trajectory information, and user's e-mail information. The social network information includes a writing that a user wrote on a social network such as Twitter or Facebook and a writing transferred to the user. The trajectory information is information for a user's real trajectory, and may be collected through a position tracking system such as a global positioning system (GPS). The sensor measuring data included in the received user's clinical information is measuring data for recognizing a user's activity and sentiment measured from the user, and includes clinical measuring data such as electrocardiogram, temperature, pulse, weight, BMI, and muscular condition and the user's motion measuring data.

When the user's clinical information is received, the method includes converting a data format of the received user's clinical information into an HL7 vMR format (402). The received user's clinical information may have different data formats according to a collecting apparatus, a medical institution, or a kind of sensor. The HMIS such as EMR and EHR uses a standard format used in a corresponding field such as HL7 CDA, openEHR, and CEN13606, and may use an independent individual format according to the user's clinical information. In order to maintain interoperability between systems using different formats, the received clinical information is converted into the HL7 vMR. The HL7 provides standard format which can allow health medical field software applications different from each other to be compatible, and is one of standards for electronic exchange of clinical information. The HL7 vMR format is an interface format supported in the HL7 which is common data model that allows the health medical field software applications different from each other to be compatible, and is a simplified and standardized EHR data model for supporting an interface for the CDSS connection.

When the received user's clinical information is a standard format of the HMIS, a bridge service using ontology matching technology of generating a mapping between health care standards is provided. When the received user's clinical information is input as a standard data format (for example, a format such as HL7 CDA) of the HMIS, the received user's clinical information is converted into the vMR format using a previously stored ontology mapping. When the received user's clinical information is social media data, the data format of the received social media data is converted into the vMR format. The integrated clinical decision supporting apparatus according to the present invention may access and use the converted social media data regardless of kinds and data formats of the social media data by converting an individual format of the social media data including the social network, trajectory, and e-mail information into the vMR format. Further, the integrated clinical decision supporting apparatus according to the present invention may convert sensor measuring data included in the received user's clinical information into the vMR format regardless of formats.

When the received user's clinical information is converted into the HL7 vMR, the method includes analyzing the converted user's clinical information (403) and generating a medical recommendation (404). When the data format of the user's clinical information is converted into the HL7 vMR, the medical recommendation proper to the user is generated by applying the user's clinical information converted into the HL7 vMR to a clinical rule stored in a knowledge base. The generating of the medical recommendation is operated based on HL7 Arden Syntax. The medical recommendation is generated based on the clinical rule with a consistent unit type through a medical logic module (MLM) and on the converted user's clinical information. The MLM acquires a decision based on clinical knowledge or an evidence from an online resource. At the same time, the MLM is converted into an executable file format. Interoperability of a workflow can be secured by sharing the workflow with an external institution or an external CDSS through the MLM converted into the executable file format. The MLM operates on data shared by a user application in the vMR format. A user's application context is acquired from the user's clinical information received from the CDSS application terminal 200, and the workflow is set to allow the MLM to be properly performed. Since the clinical rule is stored through the MLM based on the HL7 vMR, the workflow may be shared with other medical institution or other CDSS, and various health-related information such as clinical knowledge information that the other medical institution or the other CDSS has may be shared. The medical recommendation may be more effectively generated by extracting the patient's activity state, emotion, trajectory, keyword, concept, sentiment, focused activities, and interesting pattern as described with reference to FIG. 3 according to a kind of data included in the converted user's clinical information, and applying them to the clinical rule. A detailed description was explained with reference to FIG. 3.

When the medical recommendation is generated, the method includes converting the generated medical recommendation into a data format corresponding to a counterpart terminal (405), and transmitting the medical recommendation converted into a corresponding data format to the counterpart terminal (406). Operation 405 may proceed in reverse order of operation 402. The generated medical recommendation has the HL7 vMR format. If the counterpart terminal (counterpart medical institution) receiving the generated medical recommendation uses the HL7 vMR, the generated medical recommendation may be transmitted as it is, but if the counterpart terminal uses a different format, the generated medical recommendation may be converted into a corresponding data format and transmitted to the counterpart terminal. For example, if the counterpart medical institution uses HL7 CDA which is one of standard formats of the HMIS, the medical recommendation with the HL7 vMR is converted into the HL7 CDA format which is a corresponding data format, and transmitted to the counterpart medical institution.

The present invention can be implemented as computer-readable codes in a computer-readable record medium. The computer-readable record medium includes all types of record media in which computer-readable data is stored. Examples of the computer-readable record medium include a ROM, a RAM, a CD-ROM, a magnetic tape, a floppy disk, and an optical data storage. Further, the record medium may be implemented in the form of a carrier wave such as Internet transmission. In addition, the computer-readable record medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An integrated clinical decision supporting system, comprising:
a CDSS application terminal configured to collect a user's clinical information including medical data, social media data, and sensor measuring data, and transmit the collected user's clinical information; and
an integrated clinical decision supporting apparatus configured to convert the user's clinical information received from the CDSS application terminal into a predetermined standard format, and generate a medical recommendation based on the converted user's clinical information and a previously stored clinical rule.

2. The integrated clinical decision supporting system according to claim 1, wherein the CDSS application terminal comprises:
a health management information managing unit configured to collect the medical data for the user in an health management information system;
a social media data managing unit configured to collect the social media data including social network information, trajectory information, and e-mail information for the user; and
an activity/sentiment recognizing unit configured to collect the sensor measuring data for recognizing activity and sentiment from the user.

3. The integrated clinical decision supporting system according to claim 2, wherein the medical data for the user collected in the health management information managing unit is any one format of standard formats of the health management information system including HL7 CDA, openEHR, and CEN13606.

4. The integrated clinical decision supporting system according to claim 2, wherein the sensor measuring data includes one or more of the user's temperature, body mass index, heart rate, electrocardiogram, weight, and motion measurement.

5. The integrated clinical decision supporting system according to claim 2, wherein the integrated clinical decision supporting apparatus, when the medical data for the user is received from the CDSS application terminal, converts the received medical data into the predetermined standard format through ontology matching technology of generating a mapping between health care standards of the health management information system.

6. The integrated clinical decision supporting system according to claim 1, wherein the predetermined standard format is HL7 vMR (Health Level 7 Virtual Medical Record).

7. The integrated clinical decision supporting system according to claim 1, wherein the integrated clinical decision supporting system converts the generated medical recommendation into a data format corresponding to the CDSS application terminal, and transmits the converted medical recommendation to the CDSS application terminal.

8. The integrated clinical decision supporting system according to claim 2, wherein the integrated clinical decision supporting system extracts a keyword, a concept, and a sentiment from the social network information included in the converted user's clinical information, extracts an imperative location and focused activities from the trajectory information included in the converted user's clinical information, and extracts an interesting pattern from the e-mail information included in the converted user's clinical information.

9. The integrated clinical decision supporting system according to claim 8, wherein the integrated clinical decision supporting system generates the medical recommendation considering one or more of the extracted keyword, concept, sentiment, imperative location, focused activities, and interesting pattern.

10. The integrated clinical decision supporting system according to claim 1, wherein the clinical rule is configured as a medical logic module based on HL7 Arden Syntax.

11. The integrated clinical decision supporting system according to claim 10, wherein the integrated clinical decision supporting system converts the clinical rule configured as the medical logic module into an executable file format, and shares a workflow with an external institution.

12. An integrated clinical decision supporting method, comprising:
receiving a user's clinical information including medical data, social media data, and sensor measuring data;
converting the received user's clinical information into a predetermined standard format;
generating a medical recommendation based on the converted user's clinical information and a previously stored clinical rule; and
converting the generated medical recommendation into a data format corresponding to a terminal of the user, and transmitting the converted medical recommendation to a CDSS application terminal.

13. The integrated clinical decision supporting method according to claim 12, wherein the user's clinical information comprises:
the medical data for the user collected in a health management information system;
the social media data including social network information, trajectory information, and e-mail information for the user; and
the sensor measuring data collected for recognizing an activity and a sentiment from the user.

14. The integrated clinical decision supporting method according to claim 13, wherein the sensor measuring data includes one or more of the user's temperature, body mass index, heart rate, electrocardiogram, weight, and motion measurement.

15. The integrated clinical decision supporting method according to claim 13, wherein the converting of the received user's clinical information into the predetermined standard format, when the medical data for the user is received from the CDSS application terminal, converts the received medical data into the predetermined standard format through ontology matching technology of generating a mapping between health care standards of the health management information system.

16. The integrated clinical decision supporting method according to claim 12, wherein the predetermined standard format is HL7 vMR (Health Level 7 Virtual Medical Record).

17. The integrated clinical decision supporting method according to claim 13, further comprising:
extracting a keyword, a concept, and a sentiment from the social network information included in the converted user's clinical information;
extracting an imperative location and focused activities from the trajectory information included in the converted user's clinical information; and
extracting an interesting pattern from the e-mail information included in the converted user's clinical information.

18. The integrated clinical decision supporting method according to claim 12, wherein the generating of the medical recommendation based on the converted user's clinical information and the previously stored clinical rule generates the medical recommendation considering one or more of the extracted keyword, concept, sentiment, imperative location, focused activities, and interesting pattern.

19. The integrated clinical decision supporting method according to claim 12, wherein the clinical rule is configured as a medical logic module based on HL7 Arden Syntax.

20. The integrated clinical decision supporting method according to claim 19, further comprising:
converting the clinical rule configured as the medical logic module into an executable file format; and
sharing a workflow with an external institution.
